(19) United States
(12) Patent Application Publication
(10) Pub. No.: US 2025/0177794 A1
(43) Pub. Date: Jun. 5, 2025

(54) COMPOSITION FOR USE IN THE DESTRUCTION OF NAPHTHENIC ACIDS

(71) Applicant: FLUID ENERGY GROUP LTD., Calgary (CA)

(72) Inventors: Clay PURDY, Medicine Hat (CA); Markus WEISSENBERGER, Calgary (CA); Markus PAGELS, Calgary (CA); Kyle G WYNNYK, Calgary (CA); Karl W DAWSON, Calgary (CA)

(21) Appl. No.: 18/839,150

(22) PCT Filed: Feb. 16, 2023
(86) PCT No.: PCT/CA2023/050203

§ 371 Date: Aug. 16, 2024

(30) Foreign Application Priority Data
Feb. 18, 2022 (CA) 3149493

(51) Int. Cl. A62D 3/36; A62D 3/38; A62D 101/28

(52) U.S. Cl. CPC A62D 3/36; A62D 3/38; A62D 2101/28

(57) ABSTRACT

A method for degrading naphthenic acid compounds present in naphthenic acid compounds-containing material into at least one compound of lower toxicity, said method comprising: -providing said naphthenic acid compounds-containing material; -exposing said naphthenic acid compounds-containing material to a modified Caro's acid composition for a period of time sufficient to degrade substantially all of the naphthenic acid compounds present in the naphthenic acid compound-containing material; -optionally, testing the treated material and assess a level of naphthenic acid compounds; and -optionally, releasing the treated material into a waterway.

### FIELD OF THE INVENTION

The present invention is directed to the treatment of naphthenic acids containing fluids, more specifically, to the destruction of naphthenic acid compounds

### BACKGROUND OF THE INVENTION

The oil sands resources in Canada are the third largest crude oil reserves in the world. Estimates value these reserves to approximately 170 billion barrels in the province of Alberta. The composition of the oil sands present in the Alberta fields is generally made up of 6-16 wt % bitumen, 1-8 wt % water, and 80-87 wt % sand, silt, and clay.

To extract the bitumen from the oil sands, the most common approach utilized in Western Canada is the hot water extraction. When extracting oil sands from shallow deposits, the deposit is mined and then transferred by trucks to a processing plant. At the processing plant, the mined oil sands is mixed with hot water to create slurry which can then be pumped. The bitumen is separated from the sand, clay and silt and the water by gravity separation. As a result of this process, a large volume of water is produced. On average, the process requires the equivalent of about 3 barrels of water to extract 1-barrel equivalent of oil.

The water produced as a result of this process, also referred to as OSPW (oil sands produced water) contains small amounts of bitumen and other chemicals (organics and inorganics) as well as heavy metals, the sand, silt and clay. Some of the organics include naphthenic acids, benzene, phenols and other cyclic aromatic compounds.

Oil sands produced water cannot be discharged into the environment directly in light of a zero discharge policy, and as a result, must be contained within retaining ponds, also referred to as tailing ponds. Part of OSPW is recycled in the extraction process. The ever-increasing amount of OSPW being generated as a result of oil production using hot water extraction process leads to ever-increasing volumes requiring retention and therefore an increasing urgency to address this pressing environmental issue.

Large quantities of oil sands produced water (OSPW) is generated in the production of bitumen in the Canadian oil sands. It is estimated that, in 2017, the tailing ponds in the Canadian Oil Sands region covered a surface of 220 square kilometers and accounted for a volume in excess of 1.2 trillion liters. Naphthenic acids are found within oil sands produced waters (OSPW) at concentration in an approximate range of 50-200 ppm (v). At these concentrations, naphthenic acids are the primary toxic component of oil sands produced water. Furthermore, naphthenic acids are recalcitrant and not readily degraded. With this taken into account an efficient degradation of naphthenic acids to treat oil sands produced water is desirable.

Naphthenic acids are a loosely defined group of monocyclic and polycyclic carboxylic acids. They present themselves as viscous liquids with odors due to the phenolic constituents and sulfur impurities. The chemical definition of naphthenic acids is the group of aliphatic organic carboxylic acids that contain at least one ring. These naphthenic acids are naturally present in crude oil and oil sands. The naphthenic acids are also found in the associated ground waters. The structure of naphthenic acid compounds allows them to act much like surfactants. This feature makes these compounds very difficult to remove when using oil-water separation techniques as it results in the formation of stable crude oil emulsions, and foaming within refineries, as well as cation leaching (deactivation of catalysts), each one representing a substantial operational drawback for plant operators.

Naphthenic acid compounds have the following general characteristics: aliphatic organic carboxylic acids; and the presence of one or more rings. Naphthenic acid compounds are present in crude oil, oil sands bitumen, and groundwater associated with bitumen deposits. Their concentration in crude oil can be upwards of 4% by weight. Their viscosity ranges from 40 to 100 mPas depending on the oil. With low volatility and high boiling points (upwards of 300° C.), and relatively high water solubility (compared to other organic compounds) naphthenic acid compounds are difficult to remove from oil sands produced waters. Their presence in such waters can range from 40 to 130 mg/L.

Naphthenic acid compounds result in increased corrosion to equipment when refining crude oil and can generate hazardous waste. The presence of naphthenic acids in crude oil negatively affects the quality of the latter and increases the cost of refining as well as the toxicity of the effluent containing such post-refining.

Moreover, as mentioned above, naphthenic acid compounds are the main contributors to the toxicity of oil sands produced waters. Concerns about naphthenic acid compounds are further compounded by the fact that their stability makes them among the most persistent organic compounds as they do not readily biodegrade.

The toxicity of naphthenic acid compounds has been extensively studied and some of the conclusions include the following: the toxicity is influenced by the structures, polarity, relative proportions of different individual acids, and surfactant characteristics. It was also determined that higher number of carboxylic acids led to lower toxicity compounds while higher molecular weight (keeping the number of carboxylic acid group constant) led to higher toxicity. Other features impacting the toxicity include the number of carbon atoms and cyclic rings, which have an increasing impact on toxicity while branched chains had a reverse impact on their toxicity. The concentration of naphthenic acid compounds is another factor, which impacts the toxicity of such compounds. Moreover, compounds having low solubility are also labeled as having strong sorption in soils have lower toxicity. It has been shown that by only removing naphthenic acid compounds from a body of water such as a tailing pond, the toxicity of the water is reduced to a level where living organism can survive in those same waters.

Naphthenic acid compounds share similarities with surfactants because of their polar carboxylic groups and nonpolar aliphatic ends. This allows these types of compounds to be capable of penetrating cell membranes and disrupting various natural mechanisms and consequently damaging and disrupting and damaging various organisms such as humans, birds and fish, even in parts per billion concentrations.

Given that naphthenic acid compounds are the main culprits in the toxicity of oil sands product waters, isolating these compounds is of prime importance. There have been many proposed approaches to degrade or remove naphthenic acid compounds from oil sand produced water. The following provides a listing of some of the approaches that were attempted.

The oxidation of organic compounds present in water can be a valuable approach for the degradation of such compounds. However, when the oxidation reaction of such compounds is only partial, it is possible that the resulting products are as toxic as the original naphthenic acid compounds being degraded. It is considered that ozonation should not be used as a standalone approach because of the generation of toxic intermediates. It has been suggested that it could be used in concert with microbial degradation. However, it is to be noted that oxidation is considered to be a rather expensive approach. Ozonation is an example of this type of approach. Its implementation is limited as it is a cost prohibitive approach for large bodies of water such as tailings ponds. Photolysis to create hydroxyl radicals under UV light in the presence of a photocatalyst (titanium dioxide) is another example of a proposed oxidation-based approach to degrade naphthenic acid compounds. The draw back of this approach is that the implementation of this under natural light is said to be ineffective since naphthenic acid compounds cannot absorb light in the UV wavelength region.

Another drawback of oxidation-based approach is that the presence of inorganic anions (chlorides and carbonates), quite common in oil sands produced water, can scavenge hydroxyl groups present in the water and thus greatly impact the extent of reaction of naphthenic acid compounds oxidation.

The microbial degradation of naphthenic acids is yet another possible method. However, despite the obvious advantage that is resorts to a natural approach, it is not sufficient to remove NAs in tailing ponds and the degradation rate is slow. Researchers have attempted to adopt microbial communities that are indigenous to ores and tailings to degrade NAs. It was determined that the toxicity of the compounds rendered microbial degradation not feasible, as it is a very slow process.

Coagulation/flocculation could be employed; however, since many naphthenic acid compounds are soluble in alkaline OSPW the extent of removal would be limited. One approach to overcome this problem is through the addition of iron oxide and water soluble acidic-group-containing polymer to generate flocs with the naphthenic acid compounds, which can result in an improved removal. Coagulants and flocculants chemicals are expensive, and the addition of metal coagulants/flocculants results in the increase of metal concentration in water, which may have negative health consequences on animals and humans. Coagulation and flocculation operations also result in large volumes of toxic sludge, which require additional treatment.

A various number of other approaches have been proposed, but at the present time, none of them have successfully combined the scalability factor, price and effectiveness such a large task requires. Among these other approaches there is mention of ultrasonication, membrane filtration, electrochemical oxidation, and adsorption.

For obvious environmental reasons and because there exists a real need to improve water quality, and consequently protect aquatic ecosystems, it is of great importance to address the presence of naphthenic acid compounds present in oil sands produced waters and provide solutions which can be implemented on a large scale in order to degrade or remove such compounds form tailings ponds.

In light of the state-of-the-art, there still exists a need to develop a new approach to degrade toxic naphthenic acid into less toxic compounds. The inventors have surprisingly discovered a modified acid capable of degrading naphthenic acid-containing compounds present in, for example, large retaining ponds, and thus, substantially decrease the toxicity of the chemicals contained in such ponds.

### SUMMARY OF THE INVENTION

Accordingly, there is provided a method using of a modified Caro's acid composition for the degradation of a wide variety of toxic organic chemical compounds, such as, but not limited to, naphthenic acid compounds present in large bodies of water, such as, but not limited to, tailings ponds containing oil sands produced waters.

According to an aspect of the present invention, there is provide a method for degrading naphthenic acid compounds present in naphthenic acid compounds-containing material into at least one compound of lower toxicity by an oxidation of said naphthenic acid compounds, said method comprising:
providing said naphthenic acid compounds-containing material;
exposing said naphthenic acid compounds-containing material to a modified Caro's acid composition selected from the group consisting of: composition A; composition B and Composition C;
   wherein said composition A comprises:
sulfuric acid in an amount ranging from 20 to 70 wt % of the total weight of the composition;
a compound comprising an amine moiety and a sulfonic acid moiety selected from the group consisting of: taurine; taurine derivatives; and taurine-related compounds; and
a peroxide;
   wherein said composition B comprises:
an alkylsulfonic acid; and
a peroxide; wherein the acid is present in an amount ranging from 40 to 80 wt % of the total weight of the composition and where the peroxide is present in an amount ranging from 10 to 40 wt % of the total weight of the composition;
   wherein said composition C comprises:
sulfuric acid;
a compound comprising an amine moiety;
a compound comprising a sulfonic acid moiety; and
a peroxide;
for a period of time sufficient to degrade a significant portion (preferably, substantially all) of the naphthenic acid compounds present in the naphthenic acid compound-containing material, wherein said exposure results in a treated material;
optionally, testing the treated material and assess a level of naphthenic acid compounds; and
optionally, releasing the treated material into a waterway when the assessed level of naphthenic acid compounds is below regulations.

According to an preferred embodiment of the present invention, said sulfuric acid, said compound comprising an amine moiety and a sulfonic acid moiety and said peroxide are present in a molar ratio of no less than 1:1:1.

Preferably, said sulfuric acid, said compound comprising an amine moiety and a sulfonic acid moiety and said peroxide are present in a molar ratio of no more than 15:1:1.

According to an preferred embodiment of the present invention, said sulfuric acid and said compound comprising an amine moiety and a sulfonic acid moiety are present in a molar ratio of no less than 3:1.

Preferably, said compound comprising an amine moiety and a sulfonic acid moiety is selected from the group consisting of: taurine; taurine derivatives; and taurine-related compounds.

According to an preferred embodiment of the present invention, said taurine derivative or taurine-related compound is selected from the group consisting of: sulfamic acid; taurolidine; taurocholic acid; tauroselcholic acid; tauromustine; 5-taurinomethyluridine and 5-taurinomethyl-2-thiouridine; homotaurine (tramiprosate); acamprosate; and taurates; as well as aminoalkylsulfonic acids where the alkyl is selected from the group consisting of C₁-C₅ linear alkyl and C₃-C₅ branched alkyl.

Preferably, said linear alkylaminosulfonic acid is selected form the group consisting of: methyl; ethyl (taurine); propyl; and butyl.

Preferably, branched aminoalkylsulfonic acid is selected from the group consisting of: isopropyl; isobutyl; and isopentyl.

According to an preferred embodiment of the present invention, said compound comprising an amine moiety and a sulfonic acid moiety is taurine.

According to an preferred embodiment of the present invention, said sulfuric acid and compound comprising an amine moiety and a sulfonic acid moiety are present in a molar ratio of no less than 3:1.

According to an preferred embodiment of the present invention, said compound comprising an amine moiety is an alkanolamine is selected from the group consisting of: monoethanolamine; diethanolamine; triethanolamine; and combinations thereof.

According to an preferred embodiment of the present invention, said compound comprising a sulfonic acid moiety is selected from the group consisting of: alkylsulfonic acids; arylsulfonic acids; and combinations thereof.

Preferably, said alkylsulfonic acid is selected from the group consisting of: alkylsulfonic acids where the alkyl groups range from C₁-C₆ and are linear or branched; and combinations thereof. More preferably, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; tbutylhexanesulfonic acid; and combinations thereof.

Preferably, said arylsulfonic acid is selected from the group consisting of: toluenesulfonic acid; benzesulfonic acid; and combinations thereof.

According to an preferred embodiment of the present invention, said alkylsulfonic acid; and said peroxide are present in a molar ratio of no less than 1:1.

Preferably, said compound comprising a sulfonic acid moiety is methanesulfonic acid.

According to an preferred embodiment of the present invention, said in Composition C, said sulfuric acid and said a compound comprising an amine moiety and said compound comprising a sulfonic acid moiety are present in a molar ratio of no less than 1:1:1.

Preferably, Composition C, said sulfuric acid, said compound comprising an amine moiety and said compound comprising a sulfonic acid moiety are present in a molar ratio ranging from 28:1:1 to 2:1:1.

Preferably, in Composition C, said compound comprising an amine moiety is triethanolamine and said compound comprising a sulfonic acid moiety is methanesulfonic acid.

### DETAILED DESCRIPTION OF THE PRESENT INVENTION

The description that follows, and the embodiments described therein, is provided by way of illustration of an example, or examples, of particular embodiments of the principles of the present invention. These examples are provided for the purposes of explanation, and not limitation, of those principles and of the invention.

According to a preferred embodiment of the present invention, there is provided a method useful to degrade toxic compounds such as naphthenic acids, present in large bodies of water, into less toxic or non-toxic products.

According to a preferred embodiment of the present invention, the method allows for the degradation of toxic aromatic compounds into less toxic alkanes.

According to a preferred embodiment of the present invention, the method allows for the degradation of toxic compound so the treated material (the treated water) meets local water regulations limits. More preferably, this is achieved without having to perform a second treatment of a different kind (or approach).

In order to assess the capacity for composition according to preferred embodiments of the present invention to be useful in the degradation naphthenic acid compounds, a number of lab experiments were carried out.

### Testing of Degradation of Naphthenic Acid Compounds

### Procedure

A stock solution of 99.88 ppm (v) naphthenic acid (CAS #1338-24-5) was prepared analytically. A serial dilution was completed to generate a series containing approximately 100 ppm (v), 75 ppm (v), 50 ppm (v), 25 ppm (v), 10 ppm (v) and 1 ppm (v). The UV absorbance of the naphthenic acid series was measured at 325 nm by a UV-VIS spectrophotometer. Using Lambert-Beers Law, the correlation of absorbance and concentration was found to be linear in the range of 1-100 ppm (v). The absorption coefficient was determined by a linear regression of absorbance and concentration.

The degradation of naphthenic acid was completed using a proprietary blend (10 mol H₂SO₄, 10 mol H₂O₂, 1 mol taurine, 4.99 g H₂O₂ 30% %, 4.53 g H₂SO₄ 93wt %, 0.54 g taurine) at 0.5%, 1.0% and 5.0% at ambient conditions. To a 10 mL flask, the desired amount of the proprietary blend was loaded, for the blank experiment distilled water was filled to the mark and for the kinetic experiments 99.88 ppm naphthenic acid solution was filled to the mark. The solutions were mixed by inversion for approximately 0.5 minutes and loaded into a quartz cuvette for absorption measurements (the time from the addition of naphthenic acid to the first absorption measurement was recorded).

Kinetic experiments were completed by measuring the decrease in absorption at 325 nm. The absorbance was measured over a 60 minute time period at 2.0 minute time intervals.

### Results

The results were plotted using a zero order, first order and second order rate law, where it was found, by graphical analysis, that the reaction followed a second order pathway (i.e. the plotted second order integrated rate law was most linear). Note that without a detailed kinetic study, the interpretation is a best estimate. Table 1 contains the specific rate constant and half-life of naphthenic acid in the individual kinetic experiments.

TABLE 1
Rate constant and half-life of 99.88 ppm(v) naphthenic
acid degradation using varying concentrations of blend

| Concentration of | | |
|---|---|---|
| Modified acid | k/ppm⁻¹ s⁻¹ | t_{1/2}/min |
| 0.50% | 9.06 × 10⁻⁷ | 170.21 |
| 1.00% | 7.61 × 10⁻⁷ | 203.85 |
| 5.00% | 8.25 × 10⁻⁷ | 195.88 |

From these results, it can be seen that the 100 ppm (v) naphthenic acid is most likely limiting the reaction rate because when the concentration of the proprietary blend decreases, the degradation of naphthenic acid increases (i.e. there is more naphthenic acid in solution). In all cases, the complete degradation of naphthenic acid was observed because at ten the absorption at 325 nm resulted in a concentration of less than 1 ppm (v).

### Observations

These preliminary results show that the degradation of naphthenic acid can be completed using a modified acidic composition according to a preferred embodiment at ambient conditions. The three concentrations studied resulted in a complete degradation of naphthenic acid. In addition, the reaction seems to occur at an appreciable rate, but further more detailed investigations would need to be completed to determine a universal reaction rate as compared to the experiment specific rate constants and half-life.

In light of the testing results using a method according to a preferred embodiment of the present invention, it is expected that the method could be applied to a large volume of OSPW in batch form. Upon sufficient exposure time of the aqueous modified acid compositions described herein with OSPW, and upon the assessment of the naphthenic acid content after treatment, large treated volumes of OSPW could then be further treated with another conventional method or released directly into waterways. This approach would then allow to reduce the amount of OSPW retained in tailings ponds and consequently gradually reclaim the land used by such ponds. Current local regulations prevent discharge of produced waters into rivers as such contain many compounds deleterious to the environment including naphthenic acid compounds

According to a preferred embodiment of the present invention, an acidic composition with a molar ratio of 3:1:3 of sulfuric acid (96% conc. used) to taurine to hydrogen peroxide (as 30% solution) is useful in the degradation of organic compounds, such as naphthenic acids.

### Dermal Safety of Modified Caro's Acid Composition

Even at the lowest concentration, taurine is an effective retardant for the sulfuric acid to stabilize the reaction mixture. Skin corrosiveness testing to assess the immediate corrosiveness of a composition according to a preferred embodiment of the present invention, a visual comparative assessment was carried out using chicken skin. Two chicken skin samples were secured over the opening of two beakers. The first skin sample was exposed to a solution of sulfuric acid (H₂SO₄) and hydrogen peroxide (H₂O₂). The second skin sample was exposed to a composition according to a preferred embodiment of the present invention, namely sulfuric acid; taurine: and hydrogen peroxide (H₂O₂) (in a 5.0:1.7:1.0 molar ratio)

This dermal corrosiveness test comparison between conventional Caro's Acid and a modified Caro's Acid (in a 3:1 sulfuric acid; taurine molar ratio) highlights the safety advantage of the modified Caro's acid. The sulfuric acid concentrations in Caro's acid and modified Caro's acid are approximately 80 wt % and 60 wt % respectively, whereas the hydrogen peroxide concentration was equivalent. The conventional Caro's acid leads to a breakthrough after ca. 5.5 min. The modified Caro's Acid which is to be used in a method according to a preferred embodiment of the present invention and tested breaks through the skin sample after approximately 45 minutes, but the degree of breakthrough is much smaller compared to the conventional Caro's acid. Despite the fact that this is not an OECD recognized official test, this test clearly highlights the advantages that a person, accidentally exposed to the modified Caro's acid has significantly more time available to find a safety shower to minimize irreversible skin damage and further injuries.

### Titration of Caro's Acid and a Modified Caro's Acid Composition as Used in the Present Invention

A Caro's acid (5.57:1 molar ratio of H₂SO₄:H₂O₂) and a modified Caro's acid (5.0:1.7:1.0 molar ratio of H₂SO₄:Taurine:H₂O₂) were prepared and both of which were synthesized using an ice bath and constant stirring. The compositions were stored capped, but not sealed in a water bath at a constant temperature of 30° C. To determine the concentration of H₂O₂, the solutions were titrated against a standardized KMnO₄ solution. The titration procedure follows:
1. A solution with approximately 245 mL of dH₂0 and 5 mL of 96% H₂SO₄ is prepared
2. Approximately 1 g of Caro's acid/modified Caro's acid is measured by an analytical balance and recorded
3. The diluted H₂SO₄ solution is used to quantitatively transfer the measured Caro's acid/modified Caro's acid into a 300 mL Erlenmeyer flask
4. The solution is mixed constantly with a magnetic stir plate/stir bar during the titration
5. The solution is titrated using the standardized KMnO₄ solution until the appearance of a persistent pink color for at least 1 minute. The moles of H₂O₂ found in the titrated sample and the moles of H₂O₂ used in the synthesis are used to calculate the percent yield.

The comparison between Caro's acid and the modified Caro's acid show that the modified Caro's acid has significantly more active H₂O₂ after the synthesis, and retains the activity for an extended period of time (at least 27 days); resulting in a product that has a significantly longer shelf life, increasing operational efficiency and minimizing the waste resulting from expired product.

### Batch Process-Blend Used: H₂SO₄:H₂O_{2:} Sulfamic Acid in a Molar Ratio of 10:10:1

A batch process was carried out in order to scale up the use of a composition used in a method according to a preferred embodiment of the present invention. For the preparation of a batch process, 3,301 g sulfuric acid (93%) was placed in a large glass reactor (10 L nominal volume) and 304 g sulfamic acid was added. The mixture was stirred at 100 RPM with an overhead Teflon paddle stirrer. Then 3,549 g of hydrogen peroxide solution (29%) was slowly added (1-1.5h) to the modified acid. The reactor was chilled to dissipate the generated heat so that the temperature of the blend does not exceed 40° C. After the hydrogen peroxide addition, 846 g of water was added to the mixture and the blend left to equilibrate to ambient temperature (about 30 minutes). The molar blend ratio (in order of addition) was 10:1:10

According to another preferred embodiment of the present invention, the composition can be used to decompose organic material by oxidation such as those used in water treatment, water purification and/or water desalination. An example of this is the removal (i.e. destruction) of algae on filtration membranes.

It will be appreciated that numerous specific details have been provided for a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered so that it may limit the scope of the embodiments described herein in any way, but rather as merely describing the implementation of the various embodiments described herein. And while the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. Method for degrading naphthenic acid compounds present in naphthenic acid compounds-containing material into at least one compound of lower toxicity by an oxidation of said naphthenic acid compounds, said method comprising:
providing said naphthenic acid compounds-containing material;
exposing said naphthenic acid compounds-containing material to a modified Caro's acid composition selected from the group consisting of: composition A; composition B and Composition C;
wherein said composition A comprises:
sulfuric acid in an amount ranging from 20 to 70 wt % of the total weight of the composition;
a compound comprising an amine moiety and a sulfonic acid moiety selected from the group consisting of: taurine; taurine derivatives; and taurine-related compounds; and
a peroxide;
wherein said composition B comprises:
an alkylsulfonic acid; and
a peroxide; wherein the acid is present in an amount ranging from 40 to 80 wt % of the total weight of the composition and where the peroxide is present in an amount ranging from 10 to 40 wt % of the total weight of the composition;
wherein said composition C comprises:
sulfuric acid;
a compound comprising an amine moiety;
a compound comprising a sulfonic acid moiety; and
a peroxide;
for a period of time sufficient to degrade a significant portion of the naphthenic acid compounds present in the naphthenic acid compound-containing material, wherein said exposure results in a treated material such as treated water;
optionally, testing the treated material and assess a level of naphthenic acid compounds; and
optionally, releasing the treated material into a waterway when the assessed level of naphthenic acid compounds is below local regulations levels.

2. The method according to claim 1 wherein said sulfuric acid, said compound comprising an amine moiety and a sulfonic acid moiety and said peroxide are present in a molar ratio of no less than 1:1:1.

3. The method according to claim 1 or 2, wherein said sulfuric acid, said compound comprising an amine moiety and a sulfonic acid moiety and said peroxide are present in a molar ratio of no more than 15:1:1.

4. The method according to any one of claims 1 to 3, wherein sulfuric acid and said compound comprising an amine moiety and a sulfonic acid moiety are present in a molar ratio of no less than 3:1.

5. The method according to any one of claims 1 to 4 where said compound comprising an amine moiety and a sulfonic acid moiety is selected from the group consisting of: taurine; taurine derivatives; and taurine-related compounds.

6. The method according to any one of claims 1 to 5, where said taurine derivative or taurine-related compound is selected from the group consisting of: taurolidine: taurocholic acid; tauroselcholic acid; tauromustine: 5-taurinomethyluridine and 5-taurinomethyl-2-thiouridine; homotaurine (tramiprosate); acamprosate; and taurates; as well as aminoalkylsulfonic acids where the alkyl is selected from the group consisting of C₁-C₅ linear alkyl and C₃-C₅ branched alkyl.

7. The method according to any one of claims 1 to 6, where said linear alkylaminosulfonic acid is selected form the group consisting of: methyl; ethyl (taurine); propyl; and butyl.

8. The method according to claim 7 where said branched aminoalkylsulfonic acid is selected from the group consisting of: isopropyl; isobutyl; and isopentyl.

9. The method according to any one of claims 1 to 8 where said compound comprising an amine moiety and a sulfonic acid moiety is taurine.

10. The method according to any one of claims 1 to 9, wherein said sulfuric acid and compound comprising an amine moiety and a sulfonic acid moiety are present in a molar ratio of no less than 3:1.

11. The method according to any one of claims 1 to 10, wherein said compound comprising an amine moiety is an alkanolamine is selected from the group consisting of: monoethanolamine; diethanolamine; triethanolamine; and combinations thereof.

12. The method according to any one of claims 1 to 11 wherein said compound comprising a sulfonic acid moiety is selected from the group consisting of: alkylsulfonic acids; arylsulfonic acids; and combinations thereof.

13. The method according to claim 12, wherein said alkylsulfonic acid is selected from the group consisting of: alkylsulfonic acids where the alkyl groups range from C₁-C₆ and are linear or branched; and combinations thereof.

14. The method according to claim 13, wherein said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof.

15. The method according to claim 12, wherein said arylsulfonic acid is selected from the group consisting of: toluenesulfonic acid; benzesulfonic acid; and combinations thereof.

16. The method according to claims 1 to 14 wherein said alkylsulfonic acid; and said peroxide are present in a molar ratio of no less than 1:1.

17. The method according to any one of claims 1 to 14 where said compound comprising a sulfonic acid moiety is methanesulfonic acid.

18. The method according to claims 1 to 14, wherein, in Composition C, said sulfuric acid and said a compound comprising an amine moiety and said compound comprising a sulfonic acid moiety are present in a molar ratio of no less than 1:1:1.

19. The method according to claims 1 to 14, wherein, in Composition C, said sulfuric acid, said compound comprising an amine moiety and said compound comprising a sulfonic acid moiety are present in a molar ratio ranging from 28:1:1 to 2:1:1.

20. The method according to claims 1 to 14, wherein, in Composition C, said compound comprising an amine moiety is triethanolamine and said compound comprising a sulfonic acid moiety is methanesulfonic acid.
